(19) United States
(12) Patent Application Publication
(10) Pub. No.: US 2026/0213327 A1
(43) Pub. Date: Jul. 23, 2026

(54) BATTERY MODULE

(71) Applicant: TOYOTA JIDOSHA KABUSHIKI KAISHA, Toyota-shi (JP)

(72) Inventor: Yusuke HASE, Toyota-shi (JP)

(73) Assignee: TOYOTA JIDOSHA KABUSHIKI KAISHA, Toyota-shi (JP)

(21) Appl. No.: 19/361,417

(22) Filed: Oct. 17, 2025

(30) Foreign Application Priority Data
Jan. 20, 2025 (JP) 2025-008071

(51) Int. Cl. H01M 50/264; H01M 50/249; H01M 50/258

(52) U.S. Cl. CPC H01M 50/264; H01M 50/249; H01M 50/258

(57) ABSTRACT

A restraining member includes: a body extending in the predetermined direction; and fixed ends extending in a direction intersecting the predetermined direction from both ends of the body and each facing a corresponding one of opposite end faces of the end plates, each of the opposing end faces being an end face of a corresponding one of the end plates in the predetermined direction. A fixing recess configured to receive the fixed end is provided at an end of the end face on a side closer to the body. At least part of an edge of the fixing recess on a side opposite to the body and at least part of an edge of the fixed end on the side opposite to the body has a protrusion-and-recess shape. The edge of the fixing recess and the edge of the fixed end are welded to each other.

### CROSS-REFERENCE TO RELATED APPLICATION

This application claims priority to Japanese Patent Application No. 2025-008071 filed on January 20, 2025. The disclosure of the above-identified application, including the specification, drawings, and claims, is incorporated by reference herein in its entirety.

### BACKGROUND

### Technical Field

The present disclosure relates to battery modules.

### Description of Related Art

Japanese Patent No. 7348930 (JP 7348930 B) discloses a battery module including a plurality of battery cells stacked in a predetermined direction, a pair of end plates that sandwich all of the battery cells therebetween, and a restraining member fixed to the end plates. The restraining member draws the end plates toward each other, whereby the battery cell group is restrained by the end plates.

### SUMMARY

It is conceivable to fix the end plates and the restraining member of JP 7348930 B by welding. However, when welding is used, it is not easy to achieve high fixing strength between the end plates and the restraining member.

The present disclosure has been made in consideration of the above circumstances, and an object thereof is to provide a battery module in which end plates can be fixed to a restraining member by welding while achieving high fixing strength between the end plates and the restraining member.

A battery module of a first aspect includes: a pair of end plates spaced apart in a predetermined direction; a plurality of battery cells stacked in the predetermined direction and sandwiched between the end plates; and a restraining member connected to the end plates so as to draw the end plates toward each other. The restraining member includes: a body extending in the predetermined direction; and fixed ends extending in a direction intersecting the predetermined direction from both ends of the body and each facing a corresponding one of opposite end faces of the end plates. Each of the opposing end faces is an end face of a corresponding one of the end plates in the predetermined direction. A fixing recess configured to receive the fixed end is provided at an end of the end face on a side closer to the body. At least part of an edge of the fixing recess on a side opposite to the body and at least part of an edge of the fixed end on the side opposite to the body include a protrusion-and-recess shape. The edge of the fixing recess and the edge of the fixed end are welded to each other.

In the battery module of the first aspect, the restraining member includes: the body extending in the predetermined direction; and the fixed ends extending in a direction intersecting the predetermined direction from both ends of the body and each facing a corresponding one of opposite end faces of the end plates. Each of the opposing end faces is an end face of a corresponding one of the end plates in the predetermined direction. The fixing recess configured to receive the fixed end is provided at the end of the end face of the end plate on the side closer to the body. At least part of the edge of the fixing recess on the side opposite to the body and at least part of the edge of the fixed end on the side opposite to the body have a protrusion-and-recess shape. Therefore, when the fixed end of the restraining member is fitted into the fixing recess of the end plate, the end plate and the restraining member (i.e., the fixed end) are positioned in the up-down direction. In addition, compared to a case where the entire edge of the fixing recess on the side opposite to the body and the entire edge of the fixed end on the side opposite to the body have a straight profile, the overall length of the edge of the fixing recess on the side opposite to the body and the overall length of the edge of the fixed end on the side opposite to the body become longer. This configuration increases the weld length obtained when the edges of the fixing recess and the fixed end on the side opposite to the body are joined by laser welding, making it easier to achieve high fixing strength between the end plate and the restraining member.

According to a battery module of a second aspect, in the first aspect, the protrusion-and-recess shape is a wave-shaped portion.

In the battery module of the second aspect, the end plate is less likely to be damaged when, for example, the edge of the fixed end on the side opposite to the body comes into contact with a portion of the end plate other than the fixing recess.

According to a battery module of a third aspect, in the first aspect, the protrusion-and-recess shape includes a plurality of rectangular protrusions and a plurality of rectangular recesses.

In the battery module of the third aspect, the overall length of the edge of the fixing recess on the side opposite to the body and the overall length of the edge of the fixed end on the side opposite to the body are more likely to be long.

As described above, the battery module according to the present disclosure enables the end plate and the restraining member to be fixed by welding while ensuring high fixing strength between the end plate and the restraining member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery module according to a first embodiment;

FIG. 2 is a perspective view illustrating a state in which an end plate and restraining members are separated from each other;

FIG. 3 is a front view of the battery module;

FIG. 4 is a perspective view similar to FIG. 2, illustrating a battery module according to a second embodiment; and

FIG. 5 is a front view of the battery module according to the second embodiment.

### DETAILED DESCRIPTION OF EMBODIMENTS

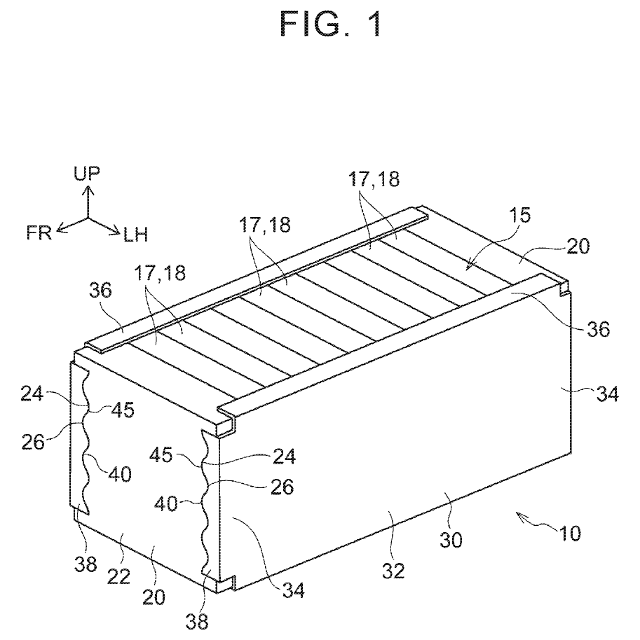

A battery module according to a first embodiment will be described below with reference to FIGS. 1 to 3. Arrows UP, FR, and LH in the drawings indicate the upward direction in the vehicle up-down direction, the forward direction in the vehicle front-rear direction, and the leftward direction in the vehicle left-right direction, respectively.

A battery module 10 according to the first embodiment is mounted on a vehicle (electrified vehicle). In the present embodiment, the vehicle is a battery electric vehicle.

The battery module 10 according to the first embodiment is housed inside a battery case (not shown) fixed to a vehicle body. Electric power from the battery module 10 (battery cells 17) is supplied to, for example, an electric motor (not shown) that provides rotational driving force to the drive wheels of the vehicle.

The battery module 10 includes a battery stack 15, end plates 20, and restraining members 30.

As shown in FIG. 1, the battery stack 15 extending in the front-rear direction includes a plurality of battery cells 17 and a plurality of insulating members (spacers) (not shown) each disposed between adjacent battery cells 17. In FIG. 1, only nine battery cells 17 are illustrated for convenience. However, the battery stack 15 actually includes more than nine battery cells 17. Each battery cell 17 is a lithium-ion cell, and a cell case 18 that defines the outer shape of the battery cell 17 has a rectangular parallelepiped shape. The cell case 18 is made of metal. The battery cells 17 are electrically connected to each other.

The battery module 10 includes a pair of front and rear end plates 20. In the present embodiment, the end plates 20 are manufactured by aluminum die casting. For example, the end plates 20 may be manufactured by vacuum die casting or laminar flow die casting. Alternatively, the end plates 20 may be made of aluminum by extrusion molding. The front end plate 20 is located immediately in front of the frontmost battery cell 17, and the rear end plate 20 is located immediately behind the rearmost battery cell 17.

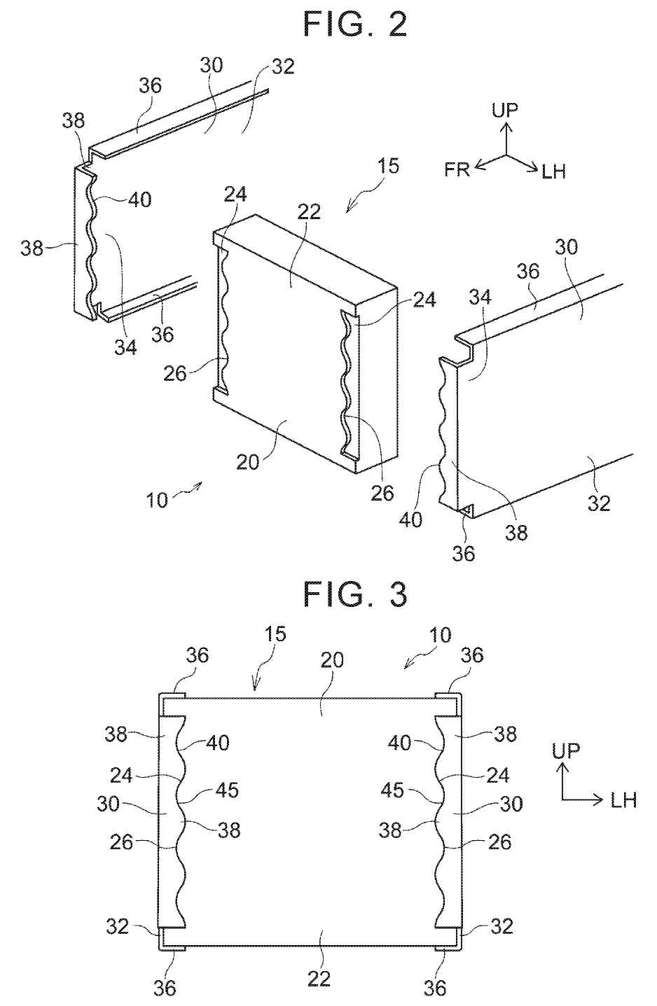

The front and rear end plates 20 are symmetrical with respect to the front-rear direction. As shown in FIG. 2, each end plate 20 has a substantially rectangular parallelepiped shape. Each of the opposite end faces 22 of the front and rear end plates 20, that is, the front end face of the front end plate 20 and the rear end face of the rear end plate 20, is provided with fixing recesses 24 at its right and left edges. The fixing recesses 24 are symmetrical with respect to the left-right direction. The upper end of each fixing recess 24 is located below the upper edge of the end face 22, and the lower end of each fixing recess 24 is located above the lower edge of the end face 22. The left end of the left fixing recess 24 and the right end of the right fixing recess 24 are both open. Moreover, the right end of the left fixing recess 24 and the left end of the right fixing recess 24 each have a protrusion-and-recess shape, rather than a straight profile extending in the up-down direction, as viewed from the front. More specifically, the right end of the left fixing recess 24 and the left end of the right fixing recess 24 are each formed as a wave-shaped portion (protrusion-and-recess shape) 26.

The pair of right and left restraining members 30 is symmetrical with respect to the left-right direction. In the present embodiment, each restraining member 30 is an aluminum press-formed product.

Each restraining member 30 includes a body 32 having a flat plate shape and extending in a direction perpendicular to the left-right direction. The body 32 has a substantially rectangular shape in which the dimension in the front-rear direction is greater than the dimension in the up-down direction, as viewed from the side. The front and rear ends of the body 32 are formed as end structures 34 whose dimension in the up-down direction is shorter than that of the remaining portion of the body 32 in the up-down direction. Each restraining member 30 includes a pair of upper and lower flanges 36. The upper and lower flanges 36 are respectively connected to the upper and lower edges of the body 32 excluding the end structures 34. Each flange 36 extends substantially perpendicularly to the body 32.

The restraining member 30 further includes a pair of front and rear fixed ends 38 respectively connected to the front and rear end structures 34. Each end structure 34 intersects a corresponding one of the fixed ends 38. The inner edge of each of the right and left fixed ends 38, namely the edge on the side opposite to a corresponding one of the end structures 34, has a protrusion-and-recess shape, rather than a straight profile extending in the up-down direction, as viewed from the front. More specifically, the inner edge of the right fixed end 38 and the inner edge of the left fixed end 38 are each formed as a wave-shaped portion (protrusion-and-recess shape) 40. Each fixed end 38 has substantially the same shape as that of a corresponding one of the fixing recesses 24, as viewed from the front. Each wave-shaped portion 40 has the same shape as that of the wave-shaped portion 26 of a corresponding one of the fixing recesses 24, as viewed from the front.

The right and left restraining members 30 are connected to the battery stack 15. That is, as shown in FIG. 1, the left restraining member 30 is brought close to the battery stack 15 from the left side, the front fixed end 38 is fitted into the left fixing recess 24 of the front end plate 20 from the front side, and the rear fixed end 38 is fitted into the left fixing recess 24 of the rear end plate 20 from the rear side. Similarly, the right restraining member 30 is brought close to the battery stack 15 from the right side, the front fixed end 38 is fitted into the right fixing recess 24 of the front end plate 20 from the front side, and the rear fixed end 38 is fitted into the right fixing recess 24 of the rear end plate 20 from the rear side. At this time, the wave-shaped portion 40 of the fixed end 38 may be in contact with the wave-shaped portion 26 of the fixing recess 24, or the wave-shaped portion 40 and the wave-shaped portion 26 may face each other with a small gap therebetween.

As a result, the upper and lower flanges 36 of the left restraining member 30 are respectively in contact with the upper and lower surfaces of each battery cell 17, or respectively face the upper and lower surfaces of each battery cell 17 with a small gap therebetween. In addition, the inner surface of the body 32 of the left restraining member 30 is in contact with the left side surface of each battery cell 17, or faces the left side surface of each battery cell 17 with a small gap therebetween. Similarly, the upper and lower flanges 36 of the right restraining member 30 are respectively in contact with the upper and lower surfaces of each battery cell 17, or respectively face the upper and lower surfaces of each battery cell 17 with a small gap therebetween. In addition, the inner surface of the body 32 of the right restraining member 30 is in contact with the right side surface of each battery cell 17, or faces the right side surface of each battery cell 17 with a small gap therebetween. When the right and left restraining members 30 are mounted to the battery stack 15 in this manner, the length of each restraining member 30 in the front-rear direction becomes longer than in its free state. Therefore, the restraining members 30 draw the front and rear end plates 20 toward each other. The battery stack 15 is thus clamped in the front-rear direction by the front and rear end plates 20.

Furthermore, the front surfaces of the front fixed ends 38 of the right and left restraining members 30 are flush with the end face 22 of the front end plate 20, and the rear surfaces of the rear fixed ends 38 of the right and left restraining members 30 are flush with the end face 22 of the rear end plate 20.

The wave-shaped portion 40 of the front fixed end 38 of each of the right and left restraining members 30 is joined to the wave-shaped portion 26 of a corresponding one of the fixing recesses 24 of the front end plate 20 by laser welding. That is, a weld portion 45 is formed along the entire wave-shaped portion 40 of the front fixed end 38 of the right restraining member 30 and the entire wave-shaped portion 26 of the right fixing recess 24 of the front end plate 20, and another weld portion 45 is formed along the entire wave-shaped portion 40 of the front fixed end 38 of the left restraining member 30 and the entire wave-shaped portion 26 of the left fixing recess 24 of the front end plate 20. Therefore, the wave-shaped portion 40 of the front fixed end 38 of each of the right and left restraining members 30 is fixed to the wave-shaped portion 26 of a corresponding one of the fixing recesses 24 of the front end plate 20.

Although not shown in the figures, the wave-shaped portion 40 of the rear fixed end 38 of each of the right and left restraining members 30 is joined to the wave-shaped portion 26 of a corresponding one of the fixing recesses 24 of the rear end plate 20 by laser welding. Accordingly, a weld portion 45 is formed along the entire wave-shaped portion 40 of the rear fixed end 38 of the right restraining member 30 and the entire wave-shaped portion 26 of the right fixing recess 24 of the rear end plate 20, and another weld portion 45 is formed along the entire wave-shaped portion 40 of the rear fixed end 38 of the left restraining member 30 and the entire wave-shaped portion 26 of the left fixing recess 24 of the rear end plate 20. Therefore, the wave-shaped portion 40 of the rear fixed end 38 of each of the right and left restraining members 30 is fixed to the wave-shaped portion 26 of a corresponding one of the fixing recesses 24 of the rear end plate 20.

### Functions and Effects

Next, the functions and effects of the first embodiment will be described.

In the battery module 10 of the first embodiment, each restraining member 30 includes the body 32 extending in the front-rear direction, and the fixed ends 38 respectively extending in the left-right direction from both ends of the body 32 (i.e., from both ends of the end structures 34) and each facing the end face 22 of a corresponding one of the end plates 20 in the front-rear direction. The fixing recesses 24 into which the fixed ends 38 are fitted are formed at both ends of the end face 22 of each end plate 20 each located on the side closer to a corresponding one of the bodies 32. Furthermore, the edge of each fixing recess 24 on the side opposite to the body 32 is formed as a wave-shaped portion 26, and the edge of each fixed end 38 on the side opposite to the body 32 is formed as a wave-shaped portion 40 having a shape corresponding to that of the wave-shaped portion 26. Therefore, when the fixed ends 38 of the restraining member 30 are respectively fitted into the fixing recesses 24 of the end plates 20, the end plates 20 and the restraining member 30 (i.e., the fixed ends 38) are positioned in the up-down direction. In addition, compared to a case where the entire edge of each fixing recess 24 on the side opposite to the body 32 and the entire edge of each fixed end 38 on the side opposite to the body 32 have a straight profile extending in the up-down direction, the overall length of the edge of each fixing recess 24 on the side opposite to the body 32 and the overall length of the edge of each fixed end 38 on the side opposite to the body 32 become longer. This configuration increases the weld length obtained when the edges of the fixing recess 24 and the fixed end 38 on the side opposite to the body 32 are joined by laser welding, making it easier to achieve high fixing strength between the end plate 20 and the restraining member 30.

Moreover, the end face of each wave-shaped portion 40 of the restraining member 30 has a curved shape. Therefore, for example, even if the wave-shaped portion 40 of the restraining member 30 comes into contact with a portion of the end plate 20 other than the fixing recess 24 during connection of the restraining member 30 to the end plate 20, the end plate 20 is less likely to be damaged by the restraining member 30.

Furthermore, the front surfaces of the front fixed ends 38 of the right and left restraining members 30 are flush with the end face 22 of the front end plate 20, and the rear surfaces of the rear fixed ends 38 of the right and left restraining members 30 are flush with the end face 22 of the rear end plate 20. Therefore, the dimension of the battery module 10 in the front-rear direction can be reduced compared to a case where, for example, the front surfaces of the front fixed ends 38 of the right and left restraining members 30 are located forward of the end face 22 of the front end plate 20, or the rear surfaces of the rear fixed ends 38 of the right and left restraining members 30 are located rearward of the end face 22 of the rear end plate 20.

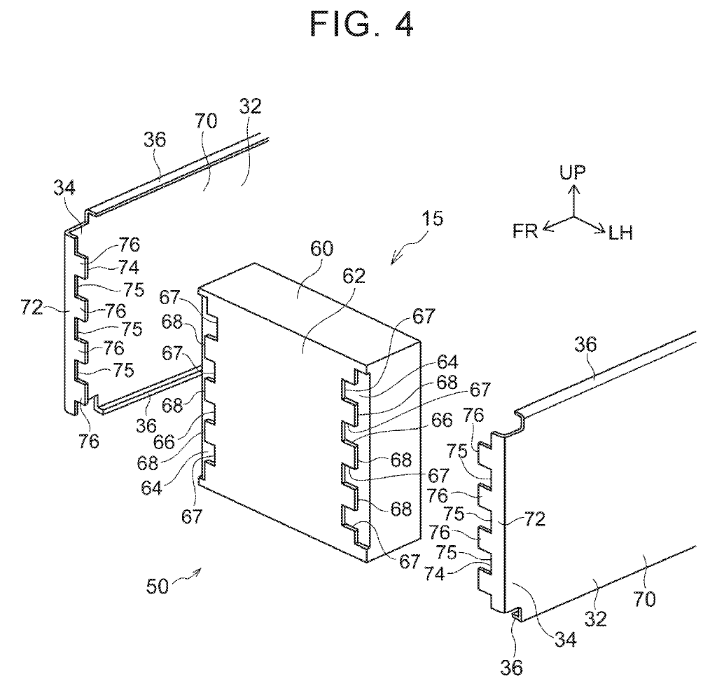

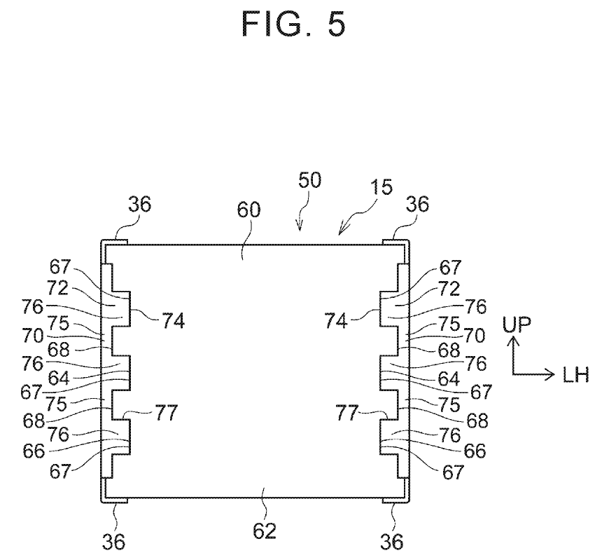

Next, a battery module according to a second embodiment will be described with reference to FIGS. 4 and 5. The same components as those of the first embodiment are denoted by the same signs, and detailed description thereof will be omitted.

A battery module 50 according to the second embodiment is different from the first embodiment in the shapes of end plates 60 and restraining members 70. The material and manufacturing method of the end plates 60 are substantially the same as those in the first embodiment, and the material and manufacturing method of the restraining members 70 are also substantially the same as those in the first embodiment.

The front and rear end plates 60 are symmetrical with respect to the front-rear direction. As shown in FIG. 4, each end plate 60 has a substantially rectangular parallelepiped shape. Fixing recesses 64 that are symmetrical with respect to the left-right direction are formed at the right and left edges of the opposite end faces 62 of the end plates 60. The upper end of each fixing recess 64 is located below the upper edge of the end face 22, and the lower end of each fixing recess 64 is located above the lower edge of the end face 22. The left end of the left fixing recess 64 and the right end of the right fixing recess 64 are both open. Moreover, the right end of the left fixing recess 64 and the left end of the right fixing recess 64 each have a protrusion-and-recess shape, rather than a straight profile extending in the up-down direction, as viewed from the front. More specifically, the right end of the left fixing recess 64 and the left end of the right fixing recess 64 are each formed as a rectangular protrusion-and-recess structure (protrusion-and-recess shape) 66. The rectangular protrusion-and-recess structure 66 has a shape in which substantially square recesses 67 and substantially square protrusions 68 are arranged alternately in the up-down direction.

The pair of right and left restraining members 70 is symmetrical with respect to the left-right direction. Each restraining member 70 includes a pair of front and rear fixed ends 72 respectively connected to the front and rear end structures 34. Each end structure 34 intersects a corresponding one of the fixed ends 72. The inner edge of each of the right and left fixed ends 72, namely the edge on the side opposite to a corresponding one of the end structures 34, has a protrusion-and-recess shape, rather than a straight profile extending in the up-down direction, as viewed from the front. More specifically, the inner edge of the right fixed end 72 and the inner edge of the left fixed end 72 are each formed as a rectangular protrusion-and-recess structure (protrusion-and-recess shape) 74. The rectangular protrusion-and-recess structure 74 has substantially the same shape as that of the rectangular protrusion-and-recess structure 66, as viewed from the front. The rectangular protrusion-and-recess structure 66 has a shape in which substantially square recesses 75 and substantially square protrusions 76 are arranged alternately in the up-down direction.

The right and left restraining members 70 are connected to the battery stack 15. That is, the left restraining member 70 is brought close to the battery stack 15 from the left side, the front fixed end 72 is fitted into the left fixing recess 64 of the front end plate 60 from the front side, and the rear fixed end 72 is fitted into the left fixing recess 64 of the rear end plate 60 from the rear side. Similarly, the right restraining member 70 is brought close to the battery stack 15 from the right side, the front fixed end 72 is fitted into the right fixing recess 64 of the front end plate 60 from the front side, and the rear fixed end 72 is fitted into the right fixing recess 64 of the rear end plate 60 from the rear side.

As a result, the upper and lower flanges 36 of the left restraining member 70 are respectively in contact with the upper and lower surfaces of each battery cell 17, or respectively face the upper and lower surfaces of each battery cell 17 with a small gap therebetween. In addition, the inner surface of the body 32 of the left restraining member 70 is in contact with the left side surface of each battery cell 17, or faces the left side surface of each battery cell 17 with a small gap therebetween. Similarly, the upper and lower flanges 36 of the right restraining member 70 are respectively in contact with the upper and lower surfaces of each battery cell 17, or respectively face the upper and lower surfaces of each battery cell 17 with a small gap therebetween. In addition, the inner surface of the body 32 of the right restraining member 70 is in contact with the right side surface of each battery cell 17, or faces the right side surface of each battery cell 17 with a small gap therebetween. When the right and left restraining members 70 are mounted to the battery stack 15 in this manner, the length of each restraining member 70 in the front-rear direction becomes longer than in its free state. Therefore, the restraining members 70 draw the front and rear end plates 60 toward each other. The battery stack 15 is thus clamped in the front-rear direction by the front and rear end plates 60.

Furthermore, the front surfaces of the front fixed ends 72 of the right and left restraining members 70 are flush with the end face 62 of the front end plate 60, and the rear surfaces of the rear fixed ends 72 of the right and left restraining members 70 are flush with the end face 62 of the rear end plate 60.

The rectangular protrusion-and-recess structure 74 of the front fixed end 72 of each of the right and left restraining members 70 is joined to the rectangular protrusion-and-recess structure 66 of a corresponding one of the fixing recesses 64 of the front end plate 60 by laser welding. That is, a weld portion 77 is formed along the entire inner edge of the rectangular protrusion-and-recess structure 74 of the front fixed end 72 of the right restraining member 70 and the entire inner edge of the rectangular protrusion-and-recess structure 66 of the right fixing recess 64 of the front end plate 60, and another weld portion 77 is formed along the entire inner edge of the rectangular protrusion-and-recess structure 74 of the front fixed end 72 of the left restraining member 70 and the entire inner edge of the rectangular protrusion-and-recess structure 66 of the left fixing recess 64 of the front end plate 60. At this time, (the inner edge of) the rectangular protrusion-and-recess structure 74 of the fixed end 72 may be in contact with (the inner edge of) the rectangular protrusion-and-recess structure 66 of the fixing recess 64, or (the inner edge of) the rectangular protrusion-and-recess structure 74 and (the inner edge of) the rectangular protrusion-and-recess structure 66 may face each other with a small gap therebetween. Therefore, the rectangular protrusion-and-recess structure 74 of the front fixed end 72 of each of the right and left restraining members 70 is fixed to the rectangular protrusion-and-recess structure 66 of a corresponding one of the fixing recesses 64 of the front end plate 60.

Although not shown in the figures, the rectangular protrusion-and-recess structure 74 of the rear fixed end 72 of each of the right and left restraining members 70 is joined to the rectangular protrusion-and-recess structure 66 of a corresponding one of the fixing recesses 64 of the rear end plate 60 by laser welding. That is, a weld portion 77 is formed along the entire inner edge of the rectangular protrusion-and-recess structure 74 of the rear fixed end 72 of the right restraining member 70 and the entire inner edge of the rectangular protrusion-and-recess structure 66 of the right fixing recess 64 of the rear end plate 60, and another weld portion 77 is formed along the entire inner edge of the rectangular protrusion-and-recess structure 74 of the rear fixed end 72 of the left restraining member 70 and the entire inner edge of the rectangular protrusion-and-recess structure 66 of the left fixing recess 64 of the rear end plate 60. Therefore, the rectangular protrusion-and-recess structure 74 of the rear fixed end 72 of each of the right and left restraining members 70 is fixed to the rectangular protrusion-and-recess structure 66 of a corresponding one of the fixing recesses 64 of the rear end plate 60.

### Functions and Effects

Next, the functions and effects of the second embodiment will be described.

In the battery module 50 of the second embodiment, each restraining member 70 includes the body 32 extending in the front-rear direction, and the fixed ends 72 respectively extending in the left-right direction from both ends of the body 32 (i.e., from both ends of the end structures 34) and each facing the end face 62 of a corresponding one of the end plates 60 in the front-rear direction. The fixing recesses 64 into which the fixed ends 72 are fitted are formed at both ends of the end face 62 of each end plate 60 each located on the side closer to a corresponding one of the bodies 32. Furthermore, the edge of each fixing recess 64 on the side opposite to the body 32 is formed as a rectangular protrusion-and-recess structure 66, and the edge of each fixed end 72 on the side opposite to the body 32 is formed as a rectangular protrusion-and-recess structure 74 having a shape corresponding to that of the rectangular protrusion-and-recess structure 66. Therefore, when the fixed ends 72 of the restraining member 70 are respectively fitted in the opposite end faces 62 of the end plates 60, the end plates 60 and the restraining member 70 (i.e., the fixed ends 72) are positioned in the up-down direction. In addition, compared to a case where the entire edge of each fixing recess 64 on the side opposite to the body 32 and the entire edge of each fixed end 72 on the side opposite to the body 32 have a straight profile extending in the up-down direction, the overall length of the edge of each fixing recess 64 on the side opposite to the body 32 and the overall length of the edge of each fixed end 72 on the side opposite to the body 32 become longer. More specifically, the overall length of the edge of each fixing recess 64 on the side opposite to the body 32 and the overall length of the edge of each fixed end 72 on the side opposite to the body 32 become longer than the overall length of the edge of each fixing recess 24 on the side opposite to the body 32 and the overall length of the edge of each fixed end 38 on the side opposite to the body 32 of the first embodiment, respectively. This configuration increases the weld length obtained when the edges of the fixing recess 64 and the fixed end 72 on the side opposite to the body 32 are joined by laser welding, making it easier to achieve high fixing strength between the end plate 60 and the restraining member 70.

Although the battery modules according to the embodiments have been described above, it should be understood that various design modifications may be made without departing from the spirit and scope of the present disclosure.

For example, the wave-shaped portion 26 may be formed on part of the end (edge) of the fixing recess 24 on the side opposite to the body 32 of the restraining member 30. In this case, a wave-shaped portion 40 corresponding to the wave-shaped portion 26 is formed on the fixed end 38.

For example, the rectangular protrusion-and-recess structure (protrusion-and-recess shape) 66 may be formed on the entire end (edge) of the fixing recess 64 on the side opposite to the body 32 of the restraining member 70. In this case, a rectangular protrusion-and-recess structure (protrusion-and-recess shape) 74 corresponding to the rectangular protrusion-and-recess structure 66 is formed on the fixed end 72.

The protrusion-and-recess shapes formed on the fixing recesses 24, 64 and the fixed ends 38, 72 may be different from the shapes of the wave-shaped portions 26, 40 and the rectangular protrusion-and-recess structures 66, 74. For example, the protrusion-and-recess shape may include a single protrusion 68 or 76.

The vehicle may be an electrified vehicle that is different from a battery electric vehicle and that includes an electric motor using electric power from the battery module 10. For example, the vehicle may be a hybrid electric vehicle or a plug-in hybrid electric vehicle.

What is claimed is:

1. A battery module comprising:
a pair of end plates spaced apart in a predetermined direction;
a plurality of battery cells stacked in the predetermined direction and sandwiched between the end plates; and
a restraining member connected to the end plates so as to draw the end plates toward each other, wherein:
the restraining member includes
a body extending in the predetermined direction, and
fixed ends extending in a direction intersecting the predetermined direction from both ends of the body and each facing a corresponding one of opposite end faces of the end plates, each of the opposing end faces being an end face of a corresponding one of the end plates in the predetermined direction;
a fixing recess configured to receive the fixed end is provided at an end of the end face on a side closer to the body;
at least part of an edge of the fixing recess on a side opposite to the body and at least part of an edge of the fixed end on the side opposite to the body include a protrusion-and-recess shape; and
the edge of the fixing recess and the edge of the fixed end are welded to each other.

2. The battery module according to claim 1, wherein the protrusion-and-recess shape is a wave-shaped portion.

3. The battery module according to claim 1, wherein the protrusion-and-recess shape includes a plurality of rectangular protrusions and a plurality of rectangular recesses.
